(19) United States
(12) Patent Application Publication
(10) Pub. No.: US 2026/0191126 A1
(43) Pub. Date: Jul. 9, 2026

(54) CROP PROTECTION SYSTEM FOR AN AGRICULTURAL VEHICLE AND ASSOCIATED PROTECTION METHOD

(71) Applicant: NAÏO-TECHNOLOGIES, ESCALQUENS (FR)

(72) Inventors: Joan ANDREU, AIROUX (FR); Franck JUNG, MONTLAUR (FR); Denis MOINDRAULT, MAUREMONT (FR); Bruno MATHIEU, CASTANET (FR); Cédric SEGUINEAU, AUTERIVE (FR); Gaëtan SÉVERAC, TOULOUSE (FR)

(21) Appl. No.: 19/128,200

(22) PCT Filed: Nov. 8, 2023
(86) PCT No.: PCT/EP2023/081165

§ 371 Date: May 8, 2025

(30) Foreign Application Priority Data
Nov. 9, 2022 (FR) 2211670

(51) Int. Cl. A01B 39/12; A01B 69/00; A01B 69/04

(52) U.S. Cl. CPC A01B 39/12; A01B 69/001; A01B 69/008

(57) ABSTRACT

A system for protecting a plot of crops for an agricultural vehicle. The system includes a protection device configured to measure at least one characteristic value of crops being treated. The system further includes a control unit configured to: receive a measurement of the at least one characteristic value coming from the protection device; identify the state of the crop being treated wherein the state can be a “deteriorated” state or a “preserved” state; and transmit a signal for protecting the plot of crops to the agricultural vehicle or to a remote terminal when the crop being treated is in a deteriorated state.

### CROSS REFERENCE TO RELATED APPLICATIONS

This application is a National Stage of International Application No. PCT/EP2023/081165, having an International Filing Date of 8 Nov. 2023, which designated the United States of America, and which International Application was published under PCT Article 21(2) as WO Publication No. 2024/100124, which claims priority from and the benefit of French Patent Application No. 2211670 filed on 9 Nov. 2022, the disclosures of which are incorporated herein by reference in their entireties.

### BACKGROUND

### Field

The present disclosure lies in the field of agriculture and in particular of agricultural vehicles, such as agricultural machines or autonomous agricultural robots.

More precisely, the disclosure relates to a system for protecting a plot of crops for an agricultural vehicle, designed to protect crop plots from possible damage caused by the agricultural vehicle itself, or by its tools.

The disclosure has uses in particular in agricultural vehicles, for example having automated or autonomous functions, which are dedicated to growing in low, medium or high rows, such as salads, wheat or grape vines.

### BRIEF DESCRIPTION OF RELATED DEVELOPMENTS

Agricultural vehicles configured to treat crops using treatment tools are known from the prior art. These tools can be positioned manually by an operator, directly or indirectly via a control system.

Agricultural robots moving and treating crops autonomously are also known from the prior art. These agricultural robots comprise treatment tools. Said treatment tools can comprise an autonomous positioning system, allowing them, in an optimal operating configuration, to be well positioned relative to the crops to carry out the treatment.

In both cases, the treatment operations can require a precision of positioning of the treatment tools of approximately one centimeter. For example, weeders can be used in crop plots, such as salads, and an incorrect positioning of said weeders, an incorrect use, the intrusion of an external element into the system (stones, branch, plastic residue, etc.) or an untimely dealignment of the tools (due to vibrations for example) can damage the treated crop.

An incorrect positioning or an incorrect use of the treatment tools can be due to a malfunction of the autonomous positioning system, or a malfunction of the treatment tools, the intrusion of an external element into the system (stones, branch, etc.) or an untimely dealignment of the tools (due to vibrations for example). Also, a malfunction of a control unit or of a location device can lead to inaccuracies in the treatment of the crops and damage them.

In order to verify that the treatment tools do not damage the crop plot, human supervision is currently necessary.

This solution is not satisfactory, insofar as the agricultural vehicle cannot be freely directed without supervision of the treatment carried out on the crop plots. In the case of an autonomous agricultural robot, the latter does not operate fully autonomously in the crop plots.

Nevertheless, without human supervision, at present, the entire crop can be damaged as a result of a previously mentioned malfunction.

None of the current systems allow to simultaneously meet all the required needs, namely to propose a technique for autonomous protection of a plot of crops in real time, reliable and easy to implement.

Moreover, no known technique allows to effectively prevent underground crop damage and destruction, like damage to the roots, which cannot be identified from the surface.

However, it is desirable to identify such underground deterioration and destruction, since they can have a detrimental influence on the growth of the crops and are only identifiable later.

### SUMMARY

The present disclosure aims to overcome all or a part of the disadvantages of the prior art mentioned above.

To this end, the disclosure relates to a system for protecting a plot of crops, comprising a protection device adapted to be mounted on an agricultural vehicle including at least one crop treatment tool, said vehicle comprising forward movement means allowing it to move forward in a direction “of forward movement” within a plot of crops, said crops being called upstream when they are located upstream of the at least one treatment tool before the passage of the at least one treatment tool over the crops with respect to the direction of forward movement, and said crops being called being treated when they are located at the at least one treatment tool during the passage of the at least one treatment tool over the crops.

The device for protecting the plot of crops is configured to measure at least one characteristic value of crops being treated.

Said system further comprises a control unit configured to:
receive a measurement of the at least one characteristic value coming from the protection device, in particular the size or the position in space of a crop;
identify a state of said crop being treated, wherein said state can be a “deteriorated” state or a “preserved” state;
transmit a signal for protecting the plot of crops to the agricultural vehicle or to a remote terminal when the crop being treated is in a deteriorated state.

The identification of the state of said crop being treated can in particular be a classification of the state of the crop. Indeed, the control unit can discriminate the crops according to a deteriorated state or a preserved state. However, the classification is not necessarily a step of classification into two groups in the algorithmic sense. Indeed, it is possible for only the deteriorated states to be directly identified, and optionally recorded in a storage memory, the preserved states being indirectly deduced from the fact that they are not deteriorated states. It is therefore possible, when a crop is in a preserved state, for no particular event (no alert, nor data archiving, nor action on the system) to be observed in the protection system. Indeed, when the crops are in preserved states during the treatment, this means that no anomaly has been detected, and that no particular action on the system is necessary.

The transmission of a protection signal is carried out when a deterioration of said crop being treated, or a strong probability of such a deterioration, has been detected. It is understood that the crop being treated has generally already been deteriorated at this stage, but the following crops, downstream, are protected by the emission of the protection signal.

The disclosure advantageously allows to establish in real time whether or not a crop being treated is capable of being deteriorated by the treatment tool. The analysis of a characteristic value of a crop during its treatment by the treatment tools allows the identification of the state of the crop being treated, which can be a deteriorated or preserved state. Thus, the disclosure advantageously allows to protect the other crops of the plot when a crop has been damaged, or when the protection device is defective.

In particular, the disclosure allows to detect a deterioration of crops that is not visible after treatment of a crop. In particular, all-terrain treatments can involve movements of the crops, which are detectable only during treatment. Thus, the disclosure allows to detect types of deteriorations of crops that were not previously detectable via the techniques of the prior art.

For example, when a treatment tool, such as a hoeing blade, passes a crop, and an abnormal behavior of the crop is detected, this can mean that there is a strong probability that the treatment tool is hitting the crop, or deteriorating its roots, for example. In particular, the physical value measured, or captured, can be an image. The abnormal behavior of a crop can manifest itself as a significant movement (such as a lifting of the crop out of the ground, a lateral shift, etc.). The device according to the disclosure allows to identify such significant movements, which can be synonymous with a deterioration of the crop, even if the crop returns to its position after passage of the treatment tool, and the deterioration is no longer visible. In other words, the disclosure allows to monitor the occurrence of a deterioration in real time at the time of passage of the treatment tools. This allows to ensure that no potential crop deterioration is ignored, and that appropriate measures can be taken as soon as possible after the deterioration has occurred.

Thus, unlike the known techniques, it is proposed with the disclosure to monitor the “instantaneous” state of a crop, during its treatment, to determine whether it may have been deteriorated, without being interested in its state after treatment, since the latter cannot be representative of its deterioration.

The disclosure also relates to a vehicle as described above, comprising a system as described above.

In a specific aspect, to identify the state of said crop being treated, the control unit is further configured to:
carry out a prediction of the state of said crop being treated via a machine learning algorithm previously trained on a set of data representative of the at least one characteristic value of the crop being treated, the state of said crop being treated being called deteriorated if said prediction exceeds a predefined threshold, and the state of said crop being treated being called preserved if said prediction does not exceed said predefined threshold.

Via the use of a trained machine learning algorithm, an identification of the state of the crop being treated can be obtained without requiring measurements other than those of characteristic values of the crop being treated.

In a preferred aspect, said machine learning algorithm is a neural network trained by supervised learning on said set of data representative of the at least one characteristic value of the crop being treated, in which the data is identified as corresponding to a deteriorated state, or as corresponding to a preserved state.

Such a type of learning, called “supervised”, has the advantage of being able to precisely indicate the state of a crop to the algorithm during the learning phase, resulting in better identification, or classification, during the phase of using the algorithm.

In another specific aspect of the disclosure, to identify the state of said crop being treated, the control unit is further configured to:
compare the measurement of the at least one characteristic value of the crop being treated to a piece of data representative of at least one characteristic value of an upstream crop, corresponding to the comparison between the at least one characteristic value of said crop before the passage of the at least one treatment tool and the at least one characteristic value of said crop during the passage of the at least one treatment tool, the state of said crop being treated being called deteriorated if said comparison exceeds a predefined threshold, and the state of said crop being called preserved if said comparison does not exceed said predefined threshold.

Thus, it is possible to determine the state of the crop by a simple comparison to a piece of reference data. Such operation has the advantage of great simplicity, in particular in terms of the algorithm implemented in the control unit that executes the aforementioned steps. In addition, such operation is possible even with a limited amount of comparison data, or even a single piece of comparison data per crop type.

In a preferred aspect, the protection device is further configured to measure at least one characteristic value of upstream crops, and wherein the piece of data representative of at least one characteristic value of the upstream crop is a measurement of at least one characteristic value of the upstream crop.

Thus, the reference piece of data is particularly relevant for carrying out the comparison to the measurement of the characteristic value of the crop being treated, in particular because this is the same crop compared at two different times.

In another preferred aspect, the piece of data representative of at least one characteristic value of the upstream crop is a pre-existing piece of data stored in a non-volatile storage memory of the control unit, or in a remote non-volatile storage memory.

Thus, it is not necessary to carry out an additional measurement, allowing to save equipment. In addition, it is possible to compare the measurement of the characteristic value of the crop being treated to a single reference piece of data, or to a limited number of pieces of data. In other words, each crop is not necessarily associated with its own representative piece of data (such as a characteristic value of the same crop when it is located upstream), but with a generic representative piece of data, which can be common to several crops being treated.

These characteristic values advantageously allow to characterize a crop. If the crop is damaged (for example, cut, moved or twisted) by the treatment tools, the characteristic value of said crop before it passes through the treatment tools is different from the characteristic value of said crop after its treatment by the treatment tools.

In a specific aspect, the at least one characteristic value measured by the protection device is chosen from an image of the crop, the width of the crop, the height of the crop, the angle that the crop forms with the ground, the position of the crop, a spacing between the crop and another crop of the plot.

In a specific aspect, the treatment tool(s) are capable of adopting a working position and a rest position. The control unit is configured to transmit the signal for protecting the plot of crops to the at least one treatment tool of the agricultural vehicle, so that the at least one treatment tool is positioned in the rest position, out of the working position and the rest position it can adopt.

This advantageously allows to protect the other crops of the plot when a crop has been damaged, or when the protection device is defective, and to guide the agricultural vehicle to a location where maintenance operations can be carried out easily.

In a specific aspect, the control unit is configured to transmit the signal for protecting the plot of crops to the forward movement means to make the agricultural vehicle stop.

In a specific aspect, a device for protecting the crops comprises an image sensor and/or a laser sensor.

These aspects provide the advantage to said protection device of limiting its bulk and its mass.

In a specific aspect, the system comprises a location device, wherein the control unit is configured to associate the measurement of the at least one characteristic value of the crop being treated with a position of the crop being treated estimated by the location device.

This aspect has the advantage of improving the reliability of the association of the measurements of the characteristic values of the same crop, in particular upstream and being treated, at two given times.

In a specific aspect, the control unit is remote from the agricultural vehicle, and wherein the protection device comprises wireless communication means adapted to transmit data from the control device to the control unit, and vice versa.

In this way, the operations carried out by the control unit can be outsourced and carried out remotely. This has the advantage of having, for example, a greater computing capacity, or more storage capacity.

The disclosure also relates to an assembly comprising a crop treatment tool and a crop protection system, in which the protection device and the control unit of said system are disposed on said treatment tool.

Thus, the assembly can be adapted to any ordinary agricultural vehicle, which thus becomes an agricultural vehicle equipped with a crop protection system.

The disclosure also relates to an agricultural vehicle configured to receive such an assembly, said treatment tool being mechanically connected to said agricultural vehicle.

The disclosure also relates to an autonomous agricultural robot, including a protection system according to the disclosure.

According to a specific aspect, the robot includes a protection system, wherein the control unit of the protection system corresponds to a central control unit of said robot.

The disclosure also relates to a method for protecting a plot of crops implemented by a protection system, including the steps of:
Measurement by the protection device of at least one characteristic value of a crop being treated;
Transmitting said measurement to the control unit;
Identifying the state of said crop being treated, wherein said state can be a “deteriorated” state or a “preserved” state;
Transmitting a signal for protecting the plot of crops to the agricultural vehicle or to a remote terminal when the crop being treated is in a deteriorated state.

In a specific aspect, implemented by a protection system according to a first aspect, the classification step includes the steps of:
Carrying out a prediction of the state of said crop being treated via a machine learning algorithm previously trained on a set of data representative of the at least one characteristic value of the crop being treated, the state of said crop being treated being called deteriorated if said prediction exceeds a predefined threshold, and the state of said crop being treated being called preserved if said prediction does not exceed said predefined threshold.

In another specific aspect, implemented by a protection system according to a second aspect, the classification step includes the steps of:
Association by the control unit of the measurement of a crop being treated coming from the protection device with a piece of data representative of at least one characteristic value of an upstream crop;
Comparison by the control unit of said measurement to said piece of data representative of at least one characteristic value of an upstream crop, the state of said crop being treated being called deteriorated if said comparison exceeds a predefined threshold, and the state of said crop being treated being called preserved if said comparison does not exceed said predefined threshold.

In a preferred aspect, implemented by a protection system comprising a location device, the method includes an additional preliminary step of recording of the location of a crop by the location device, and the step of association by the control unit comprising a first association of a measurement of the at least one characteristic value of a crop being treated coming from the protection device with a position estimated by the location device of the characterized crop and a second association of a measurement coming from the protection device and of a piece of data representative of at least one characteristic value of an upstream crop associated with the position of the crop being treated.

This allows to improve the reliability of the association of the measurements of the characteristic values, coming from the protection device, of the same crop at two given times, before and during the treatment by the treatment tools.

### BRIEF DESCRIPTION OF THE DRAWINGS

Other advantages, goals and specific features of the present disclosure will appear from the following non-limiting description of at least one specific aspect of the devices and methods forming objects of the present disclosure, with reference to the appended drawings, in which:

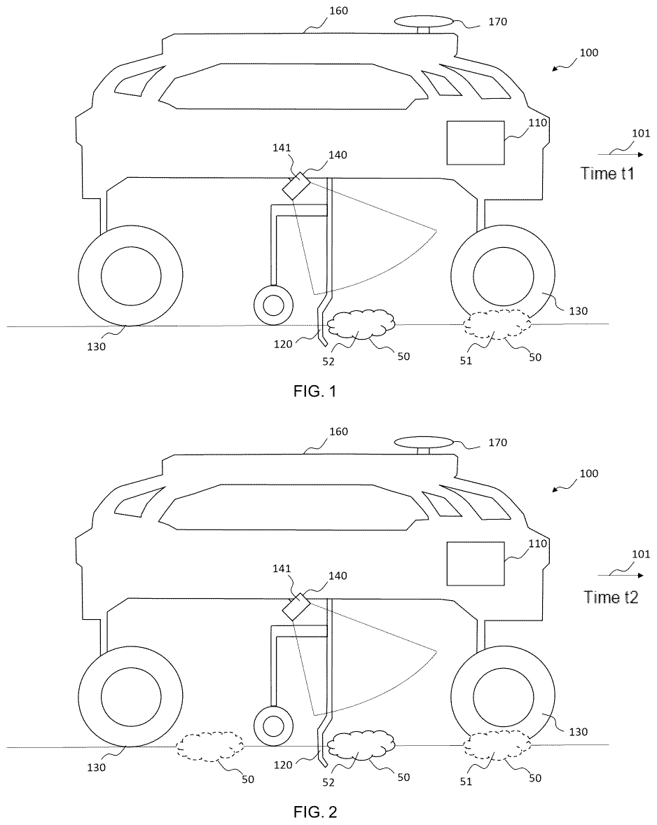

a. FIG. 1 is a schematic side view of an autonomous agricultural robot equipped with a protection system at a time t1;

b. FIG. 2 is a schematic side view of an autonomous agricultural robot equipped with a protection system in the same aspect illustrated in FIG. 1 at a time t2;

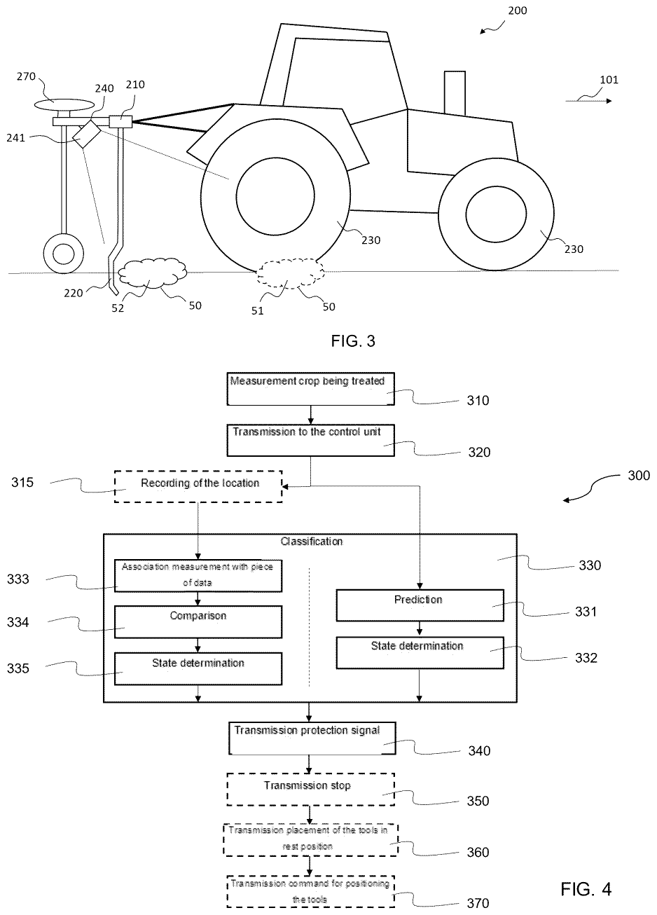

C. FIG. 3 is a schematic side view of a tractor equipped with a treatment tool with a protection system, in another aspect;

d. FIG. 4 is a flowchart illustrating the method for protecting a crop plot.

### DETAILED DESCRIPTION

The present description is given for non-limiting purposes, and each feature of an aspect can advantageously be combined with any other feature of any other aspect.

It is noted, as of now, that the drawings are not to scale.

FIG. 1 and FIG. 2 illustrate a side view of an autonomous agricultural robot 100. Said autonomous agricultural robot comprises a chassis 160 on which a control unit 110 is arranged, and treatment tools 120 allowing to treat crops 50.

The control unit 110 conventionally comprises a computer or processor.

The autonomous agricultural robot 100 can move in a crop plot 50. A crop plot 50 can comprise several crops of the same type or of different types.

The treatment tools 120 can include, in a non-limiting manner, Kress fingers, lump breaker discs, mechanical intercepts, serrated disks, or blades.

The treatment tools 120 can also be movable between two positions, a “working” position and a rest position, in particular a raised position. In the working position, the treatment tools 120 treat the crops 50. In the rest position, the treatment tools 120 do not have contact with the crops 50. All or part of the treatment tools 120, in the rest position, can be inclined substantially parallel to the ground on which the autonomous agricultural robot 100 moves. All or part of said treatment tools 120 can also be offset transversely with respect to the direction of forward movement 101.

The autonomous agricultural robot 100 can also comprise an automatic device for positioning the treatment tools 120. Said device is conventionally connected to the control unit 110. Said control unit is thus configured to transmit to it commands for positioning the treatment tools 120, said treatment tools then positioning themselves in the transmitted position.

In a non-limiting manner, the crops 50 are crops disposed in rows in the aspect described. The crops 50 can have a large size, like vine stocks, a medium size like wheat, or a small size like salads.

The autonomous agricultural robot 100 comprises forward movement means 130. Said forward movement means allow the autonomous agricultural robot 100 to move forward in a direction “of forward movement” 101.

The control unit 110 is conventionally connected to the treatment tools 120 and to the forward movement means 130. It can be configured to send a command to place the treatment tools 120 in the rest position. In this case, the treatment tools 120 are positioned in the rest position. Likewise, the control unit 110 can be configured to send a stop command to the forward movement means 130. In this case, the forward movement means brake until the autonomous agricultural robot 100 is made to stop.

The autonomous agricultural robot 100 can move forward at a speed called treatment speed during the treatment of the crop plots.

The autonomous agricultural robot 100 also comprises a device 140 for protecting the plot of crops. Protecting the plot of crops means that if a crop 50 (or a limited number of crops 50) has been damaged by the treatment tools 120, the other crops of the plot of crops 50 are protected from the treatment tools 120.

In the present exemplary aspect, the control unit of the protection system corresponds to the control unit 110 of the robot. The protection device 140 and the control unit 110 together form a system for protecting the crop plot.

Upstream crop 51 designates a crop located upstream of the treatment tools 120 before the passage of the treatment tools 120 over the crops 50 with respect to the direction of forward movement 101.

Crop being treated 52 designates a crop located at the treatment tools 120 during the passage of the treatment tools 120 over the crops 50.

Therefore, an upstream crop 51 at a time t1 can become a crop being treated 52 at a time t2, if t1 is less than t2.

The protection device 140 measures characteristic values of the crops 50.

The goal of the characteristic values measured is to be representative of the state of the crops 50.

The device 140 for protecting the plot of crops 50 can comprise a first device 141 for characterizing the upstream crops 51 and crops being treated 52. The characterization device 141 is thus disposed so that it can characterize the upstream crops 51 and the crops being treated 52 without changing orientation. For example, an orientation at an angle with respect to the ground on which the agricultural robot moves can be chosen, so as to cover a zone at the treatment tools 120 and a zone upstream of the agricultural robot.

The sensor can be connected to the control unit 110.

In a first aspect shown in FIGS. 1 and 2, the characterization device 141 can comprise image sensors. These image sensors can be CM OS sensors.

The characterization device 141 can also comprise, in an additional or complementary manner, laser sensors.

These sensors can be pointed towards the ground. They can also be oriented in a plane normal to the direction of forward movement 101, or take an intermediate orientation, for example at an angle.

The characteristic values measured can be an image of the crop.

The characteristic values can also be the width of the crop 50, the width being defined as a dimension of the crop in a plane parallel to the ground on which the autonomous agricultural robot 100 moves and perpendicular to its direction of forward movement 101.

The control unit 110 can be configured to extract the width of a crop from an image extracted from a CMOS sensor after image processing.

The characteristic values can also be the height of the crop 50. The height is defined as the dimension of the crop 50 according to an axis substantially perpendicular to the ground on which the autonomous agricultural robot 100 moves.

The control unit 110 can be configured to extract the height of a crop 50 from an image extracted from a CMOS sensor after image processing.

The characteristic values can also be the angle that the crop 50 forms with respect to the ground on which the autonomous agricultural robot 100 moves.

The characteristic values can also be the position of the crop 50.

Similarly, the characteristic values can also be a spacing between the crop 50 and another crop of the plot.

Preferably, the spacing is measured between two neighboring crops 50, that is to say one is treated just after the other by the treatment tools 120.

The control unit 110 can be configured to extract the angle that a crop 50 forms with the ground on which the autonomous agricultural robot 100 moves from an image extracted from a CMOS sensor after image processing.

The characterization device 141 can be positioned on the autonomous agricultural robot 100 respectively at the treatment tools 120 according to the direction of forward movement 101. Preferably, it is fastened onto the autonomous agricultural robot 100.

The control unit 110 is configured to receive the measurements of the characteristic values coming from the device 140 for protecting the crops 50. It can also be configured to process the measurements of the characteristic values recorded by the protection device 140 of the same crop 50 during the passage of the treatment tools 120, and optionally before the passage of the treatment tools 120.

The control unit 110 is configured to receive said measurements of the characteristic values coming from the protection device 140.

The control unit 110 is also configured to identify a state of the crop being treated 52, wherein said state can be a “deteriorated” state or a “preserved” state.

The identification of the state of the crop being treated 52 can be carried out in several ways, which will be explained in the rest of the description.

When the state of the crop being treated is identified as being a deteriorated state, the control unit 110 can be configured to send a protection signal to the autonomous agricultural robot 100, or to an external terminal.

The protection signal can take the form of a protection command sent to the autonomous agricultural robot.

In this case, the protection signal can take the form of a stop command directly sent to the agricultural vehicle, also capable of taking several forms.

Thus, the control unit 110 can be configured to send a stop command to the forward movement means 130.

Also, the control unit 110 can be configured to transmit a command to place the treatment tools 120 in the rest position.

Furthermore, the protection signal can take the form of a protection signal sent to a remote terminal. Such a protection signal thus takes the form of an alert or an error message to an external medium intended for an operator, for example inviting an operator to act on the agricultural vehicle.

These protection signals can be cumulated.

Optionally, before transmitting a protection signal, it is possible to carry out an automatic adjustment of the treatment tools 120. Such an adjustment can for example consist in repositioning all or part of the treatment tools 120.

As presented above, the state of the crop being treated 52 can be identified as a “deteriorated” state, or a “preserved” state.

According to a first alternative, the identification of the state of the crop being treated 52 can be carried out via a machine learning algorithm.

More precisely, the control unit 110 is thus configured to carry out a prediction of the state of said crop being treated 52 via a machine learning algorithm.

Such a machine learning algorithm can for example be a neural network.

The neural network can also be of the convolutional type (known by the acronym CNN).

The machine learning algorithm is previously trained on a set of data representative of the at least one characteristic value of the crop being treated 52.

The training data can have been generated during previous measurements. It is also possible to enrich measured data in order to generate a larger set of training data. For example, in the case of a characteristic value corresponding to an image, a captured image can be decolorized, detextured, rotated, cropped, etc.

According to a first possibility, the learning on the basis of the dataset is unsupervised, that is to say that the data of the dataset is not labeled or identified. In other words, it is not specified whether a piece of data is associated with a deteriorated state or a preserved state.

According to a second possibility, the learning on the basis of the dataset is preferably supervised. In this case, the data is identified as corresponding to a deteriorated state, or as corresponding to a preserved state.

In particular, the characteristic value corresponds to an image. Such a type of characteristic value is particularly adapted for use with neural networks, with a view to image classification.

The image of a preserved crop can for example be identified by a regular orientation of the crops.

The image of a deteriorated crop can for example be identified by an irregular orientation of all or part of the crops 50. Indeed, for example when the treatment tools 120 work underground, an unintended deterioration of the roots can manifest itself by a movement of the crops 50 during the passage of the treatment tools 120.

For example, when the characterization device 141 is an image sensor or camera, the latter can capture a stream of images, for example a stream of 5 to 60 images per second.

Each image of the stream can be processed by the previously trained neural network. The output of the neural network corresponds to a prediction of the state of said crop being treated 52. This prediction can take the form of a probability, for example expressed by a number between 0 and 1, that the crop is in a deteriorated state, or vice versa, that it is in a preserved state.

The crop being treated 52 is then classified as being in a deteriorated state if the prediction exceeds a predefined threshold, otherwise it is classified as being in a preserved state, if the prediction does not exceed said predefined threshold.

The predefined threshold can be set by an operator of the autonomous robot 100. For example, the predefined threshold can be set to between 0.7 and 0.95, corresponding to a probability ranging from 70% to 95% that the crop being treated 52 is in a deteriorated state.

According to a second alternative, the identification of the state of the crop being treated 52 can be carried out via a comparison to a piece of data representative of a characteristic value of an upstream crop 51.

The control unit 110 can thus be configured to carry out a comparison between the measurement of a characteristic value of the crop 50 being treated 52 and a piece of data representative of a characteristic value of an upstream crop 51, corresponding to the comparison between a characteristic value of the crop before the passage of the treatment tools 120, and a characteristic value of said crop during the passage of the treatment tools 120.

According to a first possibility, measurements of the characteristic values of the same crop 50 before and during the passage of the treatment tools 120 are recorded by the protection device 140.

In such a case, the protection device 140 is configured to measure at least one characteristic value of upstream crops 51, for example also via the characterization device 141.

The piece of data representative of a characteristic value of the upstream crop 51 is thus a measurement of a characteristic value of the upstream crop 51.

According to a second possibility, the control unit 110 is configured to carry out a comparison of the measurements of the characteristic values recorded by the protection device 140 of the same crop 50 during the passage of the treatment tools 120 to a piece of data representative of at least one characteristic value of an upstream crop 51, which is different from a measurement.

The control unit 110 is thus configured to associate the measurement of a characteristic value of a crop being treated 52 with a piece of data representative of a characteristic value of an upstream crop 51.

For example, the piece of data representative of a characteristic value is a pre-existing piece of data stored in a non-volatile storage memory of the control unit 110, or in a remote, in particular non-volatile, storage memory.

The pre-existing piece of data can for example have been generated during an earlier use of the agricultural robot, or during an independent data generation operation. For example, it is possible to generate a set of pre-existing data by flying over the plot of crops via a drone equipped with a device for characterizing the crops, such as a camera.

It is also possible for the pre-existing piece of data to be a single image of a crop 50 in a preserved state. Such an image is then used as a reference for all the crops being treated 52.

Regardless of the type of piece of data representative of a characteristic value of an upstream crop 51, the control unit 110 is configured to identify the state of the crop being treated 52, in particular to classify the crop being treated 52 as being in a deteriorated state if the comparison exceeds a predefined threshold, or as being in a preserved state if the comparison does not exceed the predefined threshold.

For example, when the characteristic value is a width of the crop 50, the pre-existing piece of data is the width of an upstream crop 51. The measurement of the width of the crop being treated 52 is compared to said width of the upstream crop 51. For example, a width ratio can be defined, like a ratio of width of the upstream crop 51 to the width of the crop being treated 52. According to one possibility, it can be defined that when this ratio is greater than a predefined threshold equal to 1 (indicating a lateral movement of all or part of the crops), then the crop being treated 52 is classified as being in a deteriorated state.

According to other examples of characteristic values presented above, when the characteristic value is an image, if a difference in pixels is observed between the two images of the same crop 50 before and during the treatment by the treatment tools 120, this can mean that the crop 50 has been degraded.

In particular, if the compared images do not have the same orientation, for example, it can be necessary to straighten the images in order to carry out the comparison. According to other possibilities, it can also be necessary to crop or rotate the image. It can also be useful to flatten the image, in particular to take into account the differences in height when the ground is not flat. The techniques for carrying out this type of processing are known from the prior art.

When the characteristic value is a width or a length of the crop, a difference in the characteristic values of the same crop 50 before and during the treatment by the treatment tools 120 can in particular bring to light a cutting or a tearing out, in particular underground, of the crop 50.

When the characteristic value is a position or a spacing between the crop 50 and another crop of the plot, a difference in the characteristic values of the same crop 50 before and during the treatment by the treatment tools 120 can in particular bring to light a movement or a tearing out, in particular underground, of the crop 50.

When the characteristic value is the angle that the crop 50 forms with respect to the ground on which the autonomous agricultural robot 100 moves, a difference in the characteristic values of the same crop 50 before and during the treatment by the treatment tools 120 can in particular bring to light a crushing of the crop 50, particularly if the latter is a tall crop.

Furthermore, the protection system, or the agricultural robot, can also comprise a location device 170. The location device 170 comprises for example a satellite positioning system, such as the GPS system (from the acronym Global Positioning System).

The control unit is thus configured to associate with each measurement of a characteristic value of a crop 50 a positioning of said crop, determined by the location device 170. Characteristic values associated with the same positioning are considered to be associated with the same crop 50.

### Example of a Second Embodiment

FIG. 3 illustrates an agricultural vehicle 200 equipped with a system for protecting a plot of crops according to the disclosure. The agricultural vehicle 200 here is a vehicle of the tractor type, equipped with a crop treatment tool 220 and a crop protection system. The agricultural vehicle 200 is equipped with forward movement means 230. Optionally, the agricultural vehicle 200 is equipped with a location device 270.

The crop protection system comprises a control unit 210 and a protection device 240, equipped with a characterization device 241 which can be an image or laser sensor.

In particular, the protection device 240 and the control unit 210 are disposed on the crop treatment tool 220.

However, it is possible for these elements to be disposed at any other suitable location of the agricultural vehicle 200. In particular, the control unit 210 can be remote from the agricultural vehicle 200.

The protection system of the agricultural vehicle 200 is similar to the protection system of the autonomous agricultural robot 100, by its structure and its operation.

In general, the control unit 210 is distinct from a control unit of the agricultural vehicle 200, when it has one. However, it is not excluded that the control unit 210 corresponds to a control unit of the agricultural vehicle 200.

In general, the protection signal sent by the control unit is intended for an operator. The operator then chooses to stop the agricultural vehicle 200, and/or to position the crop treatment tool 220 in the rest position. Such a signal can be displayed on a screen of the agricultural vehicle 200, or on a mobile terminal. For example, the mobile terminal can be a mobile phone or a smartwatch. However, it is possible for the protection signal to be sent directly to the agricultural vehicle 200, in the form of a protection command as mentioned above in the description.

Furthermore, the disclosure also relates to a method 300 for protecting a plot of crops 50, illustrated in FIG. 4. This method can be implemented by a protection system provided in an autonomous agricultural robot 100 or an agricultural vehicle 200 described above, in any one of its aspects, when the autonomous agricultural robot 100 or the agricultural vehicle 200 is in operation.

The method 300 comprises a first step 310 of measurement of a characteristic value of a crop being treated 52 by the protection device.

The protection device then transmits the measurement to the control unit in a step 320. The transmission of the measurements is preferably carried out in a wired manner. It can also be carried out by other transmission means.

During an identification step 330, the control unit identifies the state of the crop being treated 52. In particular, the control unit classifies the state of the crop being treated 52 as being in a “deteriorated” state, or as being in a “preserved” state.

The method 300 also comprises a step 340 of transmission of a signal for protecting the plot of crops by the control unit to the agricultural vehicle, or to a remote terminal, if the crop being treated is identified or classified as being in a deteriorated state.

The protection signal can be transmitted by the control unit to the forward movement means of the agricultural vehicle during a step 350. The forward movement means then make the autonomous agricultural vehicle stop. The plot of crops 50 is thus protected.

The protection signal can be transmitted by the control unit to the treatment tools during a step 360. This can be a command to move to the rest position. The treatment tools thus no longer have contact with the rest of the plot of crops 50. The plot of crops 50 is thus protected.

The protection signal can be transmitted by the control unit to an external operator via an external terminal or medium (not shown). The operator can then control the agricultural vehicle to secure the plot of crops 50.

The protection command can comprise, for an agricultural vehicle comprising an automatic device for positioning the treatment tools during a step 370, an analysis of the comparison and a transmission to the treatment tools of a command for positioning the treatment tools. Thus, if the characteristic value, for example, in a non-limiting manner, is an image, an analysis can be carried out on the distribution of the pixels between the image of the upstream crop 51 and the image of the crop being treated 52. For example, this comparison can bring to light that the crop being treated 52 has been damaged (cut for example) at one of its ends. This can mean that the treatment tools have gone out of alignment and are thus positioned incorrectly.

According to a first alternative, the identification is carried out via a machine learning algorithm.

The identification step 330 then includes the following steps.

A step 331 consists in carrying out a prediction of the state of the crop being treated 52 via a machine learning algorithm previously trained on a set of data representative of at least one characteristic value of the crop being treated 52.

The structure of the machine learning algorithm, which can for example be a neural network, is known from the prior art. The input piece of data of the network consists of a characteristic value of the crop being treated 52, and the output consists of a prediction taking for example the form of a probability (between 0 and 1) that a crop being treated is deteriorated.

A step 332 consists in determining the state of the crop being treated, and in particular classifying the crop being treated 52 as being in a deteriorated state if said prediction exceeds a predefined threshold, or a classification of said crop being treated as being in a preserved state if said prediction does not exceed said predefined threshold.

The predefined threshold corresponds to a probability value beyond which a crop is considered to be deteriorated.

According to a second alternative, the identification is carried out via a comparison of the measurement of a crop being treated 52 to a piece of data representative of a characteristic value of an upstream crop 51.

The identification step 330 then includes the following steps.

A step 333 consists in associating the measurement of a crop being treated with a piece of data representative of a characteristic value of an upstream crop 51.

When the method is implemented by an agricultural vehicle comprising the satellite positioning system, such as the GPS system (from the acronym Global Positioning System), the method 300 can comprise a complementary preliminary step 315. Step 315 comprises a recording of the location of the crops 50 using the satellite positioning system.

Step 333 can then comprise a first association of each measurement of characteristic values of a crop 50 by the protection device with a positioning estimated by the device for locating the characterized crop 50.

Step 333 can also comprise a second association of a measurement of characteristic values of an upstream crop 51 coming from the protection device and a measurement of characteristic values of a crop being treated 52 coming from the protection device 40, both measurements being associated with the same positioning of the characterized crop. A tolerance threshold can be applied to the positioning measurement.

The method comprises a step 334. Step 334 comprises a comparison of the measurement of a characteristic value of a crop being treated 52 to the piece of data representative of a characteristic value of an upstream crop 51.

The method also comprises a step 335 of determining the state of the crop being treated 52. The crop being treated is considered to be in a deteriorated state if the comparison exceeds a predefined threshold, to within a tolerance, or as being in a preserved state if said comparison does not exceed said predefined threshold, to within a tolerance.

In general, the predefined threshold can be set by an operator, via an external medium (not shown) connected to the control unit for example. Said threshold can depend on the tolerance of the comparison of the compared characteristic values accepted by the operator and the precision of the protection device.

The analysis of the comparison can allow to determine the distance by which the treatment tools must be repositioned so that said tools do not damage the plot of crops 50. The control unit extracts said distance and transmits it to the automatic device for positioning the treatment tools.

When the comparison is greater than the predefined threshold, the control unit can also generate a command to slow down to the forward movement means.

If after step 332 or 335, the predefined threshold is no longer exceeded for a predefined duration, the control unit can generate an order to return to the treatment speed to the forward movement means. This means that the treatment tools have been adjusted and no longer present a danger for the plot of crops 50. The predefined duration can be integrated into the control unit by the operator.

If after step 332 or 335, the predefined threshold is exceeded for a predefined duration, the control unit can generate a command to stop the agricultural vehicle. This means that the treatment tools have not been adjusted properly and that the plot of crops 50 is not secure. The predefined duration can be integrated into the control unit by the operator.

Likewise, if after step 332 or 335, the predefined threshold is exceeded for a predefined duration, the control unit can generate a command to place the treatment tools in the rest position. This means that the treatment tools have not been automatically adjusted properly and the crop plot is not secure. The predefined duration can be integrated into the control unit by the operator.

The process can comprise an additional step of maintenance of the treatment tools. The treatment tools can be adjusted by an operator.

The method can also comprise an additional step of maintenance of the device for protecting a crop plot 50.

What is claimed is:

1. A system for protecting a plot of crops, comprising a protection device adapted to be mounted on an agricultural vehicle including at least one tool for treating crops, said vehicle comprising forward movement means allowing it to move forward in a direction “of forward movement” within a plot of crops, said crops being called upstream when they are located upstream of the at least one treatment tool before the passage of the at least one treatment tool over the crops with respect to the direction of forward movement, and said crops being called being treated when they are located at the at least one treatment tool during the passage of the at least one treatment tool over the crops;
said protection device being characterized in that it is configured to:
measure at least one characteristic value of crops being treated, in particular the size or the position in space of a crop;
said system further comprising a control unit configured to:
receive a measurement of the at least one characteristic value coming from the protection device;
identify a state of said crop being treated, wherein said state can be a “deteriorated” state or a “preserved” state;
transmit a signal for protecting the plot of crops to the agricultural vehicle or to a remote terminal when the crop being treated is in a deteriorated state.

2. The system according to claim 1, wherein, to identify the state of said crop being treated, the control unit is further configured to:
carry out a prediction of the state of said crop being treated via a machine learning algorithm previously trained on a set of data representative of the at least one characteristic value of the crop being treated, the state of said crop being treated being called deteriorated if said prediction exceeds a predefined threshold, and the state of said crop being treated being called preserved if said prediction does not exceed said predefined threshold.

3. The system according to claim 2, wherein said machine learning algorithm is a neural network trained by supervised learning on said set of data representative of the at least one characteristic value of the crop being treated, in which the data is identified as corresponding to a deteriorated state, or as corresponding to a preserved state.

4. The system according to claim 1, wherein, to identify the state of said crop being treated, the control unit is further configured to:
compare the measurement of the at least one characteristic value of the crop being treated to a piece of data representative of at least one characteristic value of an upstream crop, corresponding to the comparison between the at least one characteristic value of said crop before the passage of the at least one treatment tool and the at least one characteristic value of said crop during the passage of the at least one treatment tool, the state of said crop being treated being called deteriorated if said comparison exceeds a predefined threshold, and the state of said crop being treated being called preserved if said comparison does not exceed said predefined threshold.

5. The system according to claim 4, wherein the protection device is further configured to measure at least one characteristic value of upstream crops, and wherein the piece of data representative of at least one characteristic value of the upstream crop is a measurement of at least one characteristic value of the upstream crop.

6. The system according to claim 4, wherein the piece of data representative of at least one characteristic value of the upstream crop is a pre-existing piece of data stored in a non-volatile storage memory of the control unit, or in a remote non-volatile storage memory.

7. The system according to claim 1, wherein the at least one characteristic value measured by the protection device is chosen from an image of the crop, the width of the crop, the height of the crop, the angle that the crop forms with the ground, the position of the crop, a spacing between the crop and another crop of the plot.

8. The system according to claim 1, wherein the control unit is configured to transmit the signal for protecting the plot of crops to the at least one treatment tool of the agricultural vehicle, so that the at least one treatment tool of the agricultural vehicle is positioned in a rest position, out of a working position and a rest position that it can adopt.

9. The system according to claim 1, wherein the control unit is configured to transmit the signal for protecting the plot of crops to the forward movement means to make the agricultural vehicle stop.

10. The system according to claim 1, wherein the protection device-comprises an image sensor and/or a laser sensor.

11. The system according to claim 1, comprising a location device, wherein the control unit is configured to associate the measurement of the at least one characteristic value of the crop being treated with a position of the crop being treated estimated by the location device.

12. The system according to claim 1, wherein the control unit is remote from the agricultural vehicle, and wherein the protection device comprises wireless communication means adapted to transmit data from the control device to the control unit, and vice versa.

13. (canceled)

14. An agricultural vehicle configured to receive an assembly, the assembly comprising a crop treatment tool and a crop protection system according to claim 1, wherein the protection device and the control unit of said system are disposed on said treatment tool, and said treatment tool being is mechanically connected to said agricultural vehicle.

15. (canceled)

16. (canceled)

17. A method for protecting a plot of crops implemented by a protection system according to claim 1, including the steps of:
measurement by the protection device of at least one characteristic value of a crop being treated;
transmitting said measurement to the control unit;
identifying the state of said crop being treated, wherein said state can be a “deteriorated” state or a “preserved” state; and
transmitting a signal for protecting the plot of crops to the agricultural vehicle or to a remote terminal when the crop being treated is in a deteriorated state.

18. The method for protecting a plot of crops according to claim 17, implemented by the protection system, wherein, to identify the state of said crop being treated, the control unit is further configured to carry out a prediction of the state of said crop being treated via a machine learning algorithm previously trained on a set of data representative of the at least one characteristic value of the crop being treated, the state of said crop being treated being called deteriorated if said prediction exceeds a predefined threshold, and the state of said crop being treated being called preserved if said prediction does not exceed said predefined threshold, and said machine learning algorithm is a neural network trained by supervised learning on said set of data representative of the at least one characteristic value of the crop being treated, in which the data is identified as corresponding to a deteriorated state, or as corresponding to a preserved state,
wherein the identification step includes the steps of:
carrying out a prediction of the state of said crop being treated via a machine learning algorithm previously trained on a set of data representative of the at least one characteristic value of the crop being treated, the state of said crop being treated being called deteriorated if said prediction exceeds a predefined threshold, and the state of said crop being treated being called preserved if said prediction does not exceed said predefined threshold.

19. The method for protecting a plot of crops according to claim 17, implemented by the protection system,
wherein to identify the state of said crop being treated, the control unit is further configured to compare the measurement of the at least one characteristic value of the crop being treated to a piece of data representative of at least one characteristic value of an upstream crop, corresponding to the comparison between the at least one characteristic value of said crop before the passage of the at least one treatment tool and the at least one characteristic value of said crop during the passage of the at least one treatment tool, the state of said crop being treated being called deteriorated if said comparison exceeds a predefined threshold, and the state of said crop being treated being called preserved if said comparison does not exceed said predefined threshold, and
wherein:
the protection device is further configured to measure at least one characteristic value of upstream crops, and wherein the piece of data representative of at least one characteristic value of the upstream crop is a measurement of at least one characteristic value of the upstream crop, or
the piece of data representative of at least one characteristic value of the upstream crop is a pre-existing piece of data stored in a non-volatile storage memory of the control unit, or in a remote non-volatile storage memory;
wherein the identification step includes the steps of:
Association by the control unit of the measurement of a crop being treated coming from the protection device with a piece of data representative of at least one characteristic value of an upstream crop; and
Comparison by the control unit of said measurement to said piece of data representative of at least one characteristic value of an upstream crop, the state of said crop being treated being called deteriorated if said comparison exceeds a predefined threshold, and the state of said crop being treated being called preserved if said comparison does not exceed said predefined threshold.

20. The method for protecting a plot of crops according to claim 18, implemented by the protection system where the protection system comprises a location device, wherein the control unit is configured to associate the measurement of the at least one characteristic value of the crop being treated with a position of the crop being treated estimated by the location device, the method including an additional preliminary step of recording of the location of a crop by the location device, and the step of association by the control unit comprising a first association of a measurement of the at least one characteristic value of a crop being treated coming from the protection device with a position estimated by the location device of the characterized crop and a second association of a measurement coming from the protection device and of a piece of data representative of at least one characteristic value of an upstream crop associated with the position of the crop being treated.
